(19) United States
(12) Patent Application Publication
(10) Pub. No.: US 2019/0189148 A1
(43) Pub. Date: Jun. 20, 2019

(54) MEANS AND METHODS OF CATEGORIZING PHYSIOLOGICAL STATE VIA SPEECH ANALYSIS IN PREDETERMINED SETTINGS

(71) Applicant: BEYOND VERBAL COMMUNICATION LTD., Tel-Aviv (IL)

(72) Inventor: Yoram LEVANON, Ramat Hasharon (IL)

(21) Appl. No.: 16/219,057

(22) Filed: Dec. 13, 2018

Related U.S. Application Data
(60) Provisional application No. 62/598,481, filed on Dec. 14, 2017.

(51) Int. Cl. G10L 25/66; G10L 15/08; G10L 25/63; G06F 3/16

(52) U.S. Cl. CPC G10L 25/66; G06F 3/16; G10L 25/63; G10L 15/08

(57) ABSTRACT

Systems and methods for categorizing a physiological state of a subject including acquiring physiological state data of each of predefined group of individuals; and recording audio features of said individuals in a sequence of (I) at least one first intensity stimuli, (II) at least one second intensity stimuli, and (III) at least one third intensity stimuli, and associating said audio features to said physiological state data of said group of individuals in a predetermined manner.

### FIELD OF THE INVENTION

The present invention relates to the field of categorizing a physiological state of a human subject through analyzing recordings of speeches in a sequence of predetermined settings and comparing audio feature of the subject to the constructed database.

### BACKGROUND OF THE INVENTION

Analysis and categorizing certain physiological state are gaining interests. Emotions analytics change the way we interact with our machines and ourselves. To make a determination of physiological state, a health care professional interacts either with the subject or the subject is hooked up to diagnosis or monitoring device, and further, derive conclusions about their emotional and/or physiological state.

U.S. Pat. No. 7,283,962 discloses a method and apparatus for remote evaluation of a subject's emotive and/or physiological state. Embodiments can utilize a device that can be used to determine the emotional and/or physiological state of a subject through the measurement and analysis of vital signs and/or speech. A specific embodiment relates to a device capable of remotely acquiring a subject's physiological and/or acoustic data, and then correlating and analyzing the data to provide an assessment of a subject's emotional and/or physiological state. In a further specific embodiment, the device can acquire such data, correlate and analyze the data, and provide the assessment of the subject's emotional state and/or physiological in real time.

U.S. Pat. No. 8,078,470 discloses means and method for indicating emotional attitudes of a speaker, either human or animal, according to voice intonation. It also discloses a method for advertising, marketing, educating, or lie detecting by indicating emotional attitudes of a speaker and a method of providing remote service by a group comprising at least one observer to at least one speaker. The invention also discloses a system for indicating emotional attitudes of a speaker comprising a glossary of intonations relating intonations to emotions attitudes.

The prior art in the field measures a single parameter at a time. It could not reveal the full story and does not separate emotional attitudes and physiological state of a speaker. There is therefore a long unmet need for method of categorizing or diagnosing physiological state of a person through speech analysis. The present invention emphasize on capture a process involving a variety of parameters. Through measuring many parameters under a number of different settings over a period of time, the present invention can identify and quantify variable parameters and constant parameters. This is more relevant when the emotional parameters are involved. This is also true when emotion state and physiological state-related parameters are to be measured. The present invention provides a method for differentiating emotional effect and physiological effect. Measured parameters, e.g. constant parameter under various settings, are correlated with specific physiological state, such that the specific physiological state can be categorized or diagnosed through speech analysis.

### SUMMARY OF THE INVENTION

Thus it is one object of the present invention to disclose a method for categorizing a physiological state of a subject, comprising steps of: a) constructing a database of audio features of groups of individuals; b) acquiring at least one audio feature of said subject; c) comparing said at least one audio feature with said database of audio features; and d) categorizing said subject to a predefined group within said groups of individuals. Wherein the step of constructing said database comprises steps of: i) acquiring physiological state data of each of predefined group of individuals; and

ii) recording audio features of said individuals in a sequence of (I) at least one first intensity stimuli, (II) at least one second intensity stimuli, and (III) at least one third intensity stimuli, and associating said audio features to said physiological state data of said group of individuals in a predetermined manner; said step of categorizing is by matching said at least one audio feature of said subject with the nearest fit of said audio features of said individuals from said database.

It is also an object of the present invention to provide the aforementioned method, wherein said at least one first intensity stimuli is ‘neutral’.

It is also an object of the present invention to provide the aforementioned method, wherein said at least one second intensity stimuli is ‘positive’.

It is also an object of the present invention to provide the aforementioned method, wherein said at least one third intensity stimuli is ‘negative’.

It is also an object of the present invention to provide the aforementioned method, wherein said at least one first, said at least one second and said at least one third intensity stimuli are selected from a group consisting sets of ‘high’, ‘medium’ and ‘low’; ‘medium’, ‘high’, and ‘low’; ‘medium’, ‘low’, and ‘high’; ‘low’, ‘medium’, ‘high’; and ‘low’, ‘high’, ‘medium’.

It is also an object of the present invention to provide the aforementioned method, wherein said at least one first, said at least one second and said at least one third intensity stimuli are selected from a group consisting sets of neutral, before and after a predetermined treatment, neutral, in the process of and after a predetermined treatment, before, shortly after and long after a predetermined treatment.

It is also an object of the present invention to provide the aforementioned method, wherein said physiological state data is related to medical condition selected from the group consisting of Congestive heart failure (CHF), Coronary artery disease (CAD), Cerebrovascular accident (CVA), cancer, motion disorder, neurological disease, Alzheimer's disease, Parkinson's disease, back pain, gastrointestinal diseases, Asperger's Syndrome, Posttraumatic stress disorder (PTSD), rehabilitation, and any combination thereof.

It is also an object of the present invention to provide the aforementioned method, wherein said at least one audio feature is selected from the group consisting of valence, arousal, temper, voice frequency, speaking rate, amplitude, vocal distortion, Mel-frequency cepstral coefficient (MFCC), and any combination thereof.

It is also an object of the present invention to provide the aforementioned method, wherein said recording lasts at least 30s.

It is also an object of the present invention to provide the aforementioned method, wherein said recording is performed using a microphone or a sound recorder.

It is also an object of the present invention to provide the aforementioned method, further comprising the step of transforming said recording into computer readable medium (CRM).

It is also an object of the present invention to provide the aforementioned method, wherein said recording is stored on a tape, a CD, a digital media, a computer, a smart-phone, a tablet and any combination thereof.

It is also an object of the present invention to provide the aforementioned method, wherein said recording is stored temporarily or permanently in forms of file format selected from the group consisting of way, wma, mp2, mp3, m4p, ram, and any combination thereof.

It is still another object of the present invention to provide a system for categorizing a physiological state of a subject, comprising: a) a sound recording means configured to record speeches from said subject or groups of individuals for the duration of a sample period, b) a database of audio features of groups of individuals; and c) a processor in communication with said recorder, for processing said speeches from said subject and groups of individuals so as to acquire audio features of said speeches and for categorizing said subject by matching said at least one audio feature of said subject with the nearest fit of said audio features of said individuals from said database. Wherein said database is constructed following steps of: i) acquiring physiological state data of each of predefined group of said individuals; and ii) recording audio features of said individuals in a sequence of (I) at least one first intensity stimuli, (II) at least one second intensity stimuli, and (III) at least one third intensity stimuli, and associating said audio features to said physiological state data of said group of individuals in a predetermined manner

It is still another object of the present invention to provide the aforementioned system, wherein said at least one first intensity stimuli is ‘neutral’.

It is still another object of the present invention to provide the aforementioned system, wherein said at least one second intensity stimuli is ‘positive’.

It is still another object of the present invention to provide the aforementioned system, wherein said at least one second intensity stimuli is ‘negative’.

It is still another object of the present invention to provide the aforementioned system, wherein said at least one first, said at least one second and said at least one third intensity stimuli are selected from a group consisting sets of ‘high’, ‘medium’ and ‘low’; ‘medium’, ‘high’, and ‘low’; ‘medium’, ‘low’, and ‘high’; ‘low’, ‘medium’, ‘high’; and ‘low’, ‘high’, ‘medium’.

It is still another object of the present invention to provide the aforementioned system, wherein said at least one first, said at least one second and said at least one third intensity stimuli are selected from a group consisting sets of neutral, before and after a predetermined treatment, neutral, in the process of and after a predetermined treatment, before, shortly after and long after a predetermined treatment.

It is still another object of the present invention to provide the aforementioned system, wherein said physiological state data is related to medical condition selected from the group consisting of Congestive heart failure (CHF), Coronary artery disease (CAD), Cerebrovascular accident (CVA), cancer, motion disorder, neurological disease, Alzheimer's disease, Parkinson's disease, back pain, gastrointestinal diseases, Asperger's Syndrome, Posttraumatic stress disorder (PTSD), rehabilitation, and any combination thereof.

It is still another object of the present invention to provide the aforementioned system, wherein said at least one audio feature is selected from the group consisting of valence, arousal, temper, voice frequency, speaking rate, amplitude, vocal distortion, Mel-frequency cepstral coefficient (MFCC), and any combination thereof.

It is still another object of the present invention to provide the aforementioned system, wherein said sample period lasts at least 30s.

It is still another object of the present invention to provide the aforementioned system, wherein said audio means is microphone or sound recorder.

It is still another object of the present invention to provide the aforementioned system, further comprises storage unit for said recording.

It is still another object of the present invention to provide the aforementioned system, wherein said storage unit is selected from the group consisting of a tape, a CD, a digital media, a computer, a smart-phone, a tablet and any combination thereof.

It is still another object of the present invention to provide the aforementioned system, wherein said recording is stored in said storage unit temporarily or permanently in forms of file format selected from the group consisting of way, wma, mp2, mp3, m4p, ram, and any combination thereof.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 schematically describes a flow chart of a method of categorizing physiological state of a human subject according to an embodiment of the invention.

### DETAILED DESCRIPTION OF THE PREFERRED EMBODIEMNTS

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

The term “audio feature” hereinafter refers to at least one measurable quantity that can be calculated from a sample of recorded audio, sound or speech. For example the frequency and loudness, pitch and timbre of the sound carrying the most energy is an audio feature. Example of audio features includes but are not limited to valence, arousal, temper, voice frequency, speaking rate, amplitude, vocal distortion, Mel-frequency cepstral coefficient (MFCC).

The term “physiological state” hereinafter refers to condition or state of the body or bodily functions relates to any disease, medical or health condition.

The term “subject” hereinafter refers to a person is being examined, discussed, described, or dealt with.

The term “emotion” refers hereinafter to any emotion of : affection, anger, angst, anguish, annoyance, anxiety, apathy, arousal, awe, boldness, boredom, contempt, contentment, curiosity, depression, desire, despair, disappointment, disgust, distrust, dread, ecstasy, embarrassment, envy, euphoria, excitement, fear, fearlessness, frustration, gratitude, grief, guilt, happiness, hatred, hope, honor, hostility, hurt, hysteria, indifference, interest, jealousy, joy, loathing, loneliness, love, lust, misery, panic, passion, pity, pleasure, pride, rage, regret, remorse, sadness, satisfaction, shame, shock, shyness, sorrow, suffering, surprise, tenor, trust, wonder, worry, zeal, zest, lack of interest, self-control, interpersonal communication, pragmatism, survival, conservatism, creativeness, inspiration, leadership, authority, preaching, admiring, envying, aggressiveness, hypocrisy, possessiveness, and any combination thereof.

The term “treatment” refers hereinafter to any medical care given to a subject, it also includes the use of a chemical, physical, psychological or biological agent to affect a subject.

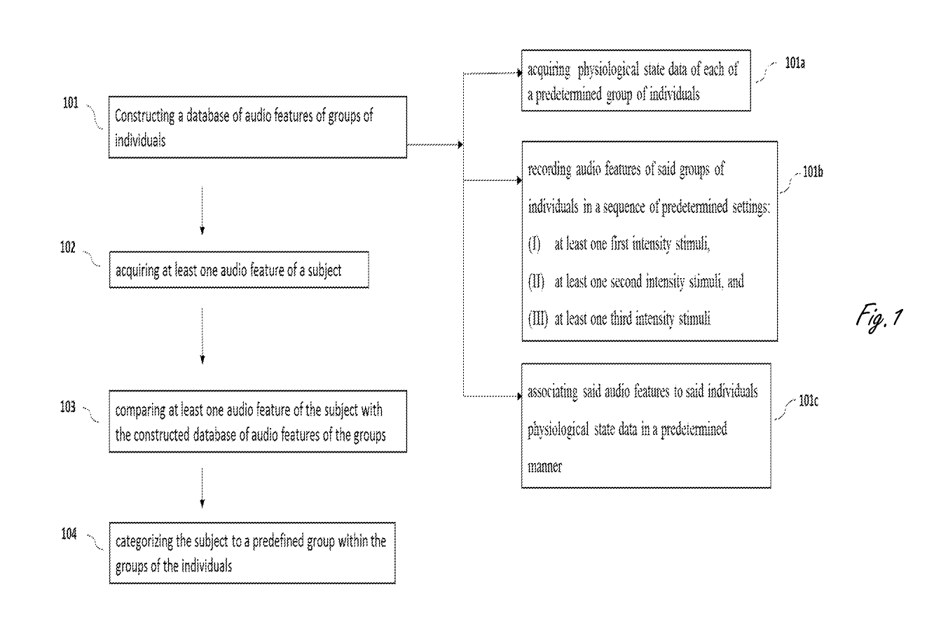

Reference is now made to FIG. 1, which schematically illustrates a high level and generalized overview of one embodiment of the invention, wherein a method of categorizing physiological state of a human subject is provided useful. The method comprises steps of constructing a database of audio features of groups of individuals (101), acquiring at least one audio feature of the subject (102), comparing one or more audio features with the acquired database of audio features (103), and categorizing the subject to a predefined group within the groups of individuals (104).

This step of ‘constructing the database’ (101) comprises, inter alia, steps of acquiring physiological state data of at least a portion of a predefined group of individuals (101a), recording audio features of those individuals in a sequence of (I) at least one first intensity stimuli, (II) at least one second intensity stimuli, and (III) at least one third intensity stimuli (101b), and then associating those one or more audio features with physiological state data of said group of individuals in a predetermined manner (101c). The groups of individuals are categorized and characterized by various physiological states. The data relating to the physiological state of each of the group is acquired via any known means including survey, heath insurance data, and diagnostic results etc. The present invention is applicable for diagnosing and/or categorizing physiological states data related medical conditions such as Congestive heart failure (CHF), Coronary artery disease (CAD), Cerebrovascular accident (CVA) or stroke, any type of cancer, motion disorder, neurological disease, Alzheimer's disease, Parkinson's disease, back pain, gastrointestinal diseases, Asperger's Syndrome, Posttraumatic stress disorder (PTSD), rehabilitation, and any combination thereof.

According to another embodiment of the technology, and embodiment which was provided, the present invention is useful for categorizing heart conditions, such as cardiovascular disease (CAD), congestive heart failure (CHF) and coronary heart disease (CHD), the first intensity is neutral, second intensity is positive and third intensity is negative.

According to yet another preferred embodiment, e.g., related to Alzheimer and Parkinson patients. In this case, the first, second and third intensity stimuli is selected from one of the following sets: ‘high’, ‘medium’ and ‘low’; ‘medium’, ‘high’, and ‘low’; ‘medium’, ‘low’, and ‘high’; ‘low’, ‘medium’, ‘high’; and ‘low’, ‘high’, ‘medium’.

According to yet another preferred embodiment, e.g. related to neurological diseases, Asperger's Syndrome, rehabilitation. In this case, e.g. the first, the second and the third stimuli are selected from a group consisting sets of neutral, before and after a predetermined treatment, neutral, in the process of and after a predetermined treatment, before, shortly after and long after a predetermined treatment.

In some embodiments of the current invention, the recording is stored on a tape, a CD or any type of digital media like a computer, smart-phone or a tablet. A professional recording in a studio with no interruptions background noise is preferable but also a simple home recording in a quite environment will be sufficient for the analysis. Each of the recording is no less than a predefined time period, e.g., 3 to 90 seconds, 20 to 40 seconds, 30s etc.

A set of speeches is selected in a language spoken by a subject. The speeches are selected so that they carry some emotional value to the speaker or neutral depending on setting.

The speeches from the subject are recorded in front of a microphone or a sound recorder in known art. The microphone translates it to an electrical signal which is accepted by the computer, converted to digital form and stored either temporarily or permanently. In the case of permanent storage, a file may be written in the hard drive or transmitted elsewhere through the network. The following: way, wma, mp2, mp3, m4p and ram are commercially available formats for storing voice recordings.

According to some preferred embodiment, the recorded speech data is analyzed by the two software modules as described in U.S. Pat. No. 8,078,470 or any speech analysis software known in the art.

### EXAMPLE 1

Recruiting a group of people having various heart conditions such as CHF and CAD, and a group of people that do not have any of the heart conditions. Divide the groups of people into healthy control group, i.e. without any heart conditions, group with CHF, group with CAD, etc.

Constructing a database by recording the speech under three different settings. Each recording should be at least 30s.

Recording 1: Speech with neutral emotion, e.g., reading text such as a phone book; Recording 2: free speech with positive emotions, e.g., telling a happy personal story; and then Recording 3: free speech with negative emotions, e.g., telling a sad or depressing personal story.

Analyzing each of the recordings within the groups of the people, extracting relevant audio features and construct the database of the groups to map out audio features in relationship to the physiological states. The audio feature acquired from a specific subject with unknown physiological state is compared to the constructed database, which then results in the categorizing the physiological state of the subject.

### EXAMPLE 2

Recruiting groups of people having gastrointestinal diseases and a group of people that do not have any of GI conditions. Divide the groups of people into healthy control group, i.e. without any GI conditions, group with specific GI disease.

Constructing a database by recording the speech under three different settings. Each recording should be at least 30s.

Recording 1: Speech with neutral emotion, e.g. reading a phone book; Recording 2: free speech under low level stress. e.g., telling a personal experience of visiting a dentist; and then Recording 3: free speech under high level stress, e.g., telling a personal story about facing life threatening situation.

Analyzing each of the recordings within the groups of the people, extracting relevant audio features and construct the database of the groups mapping out audio features in relationship to the physiological states, e.g. healthy or with specific GI disease. The audio feature acquired from a specific subject with unknown physiological state is compared to the constructed database, which result in the categorizing the physiological state of the subject.

### EXAMPLE 3

Recruiting groups of people having Alzheimer's disease and a group of people that do not have Alzheimer's disease. Divide the groups of people into healthy control group, i.e. without Alzheimer's disease, and group with Alzheimer's disease.

Constructing a database by recording the speech under three different settings. Each recording should be at least 30s.

Recording 1: Speech with neutral emotion, e.g. reading a phone book; Recording 2: free speech under low level stress, e.g. telling a personal story that requires only short term memory; then Recording 3: free speech under high level stress, e.g. telling a personal story that requires only long term memory.

Analyzing each of the recordings within the groups of the people, extracting relevant audio features and construct the database of the groups mapping out audio features in relationship to the physiological states, e.g. healthy or with Alzheimer's disease. The audio feature acquired from a specific subject with unknown physiological state is compared to the constructed database, which result in the categorizing the physiological state of the subject.

### EXAMPLE 4

Recruiting groups of people having Parkinson's disease, which is characterized by lack of dopamine and a group of people that do not have Parkinson's disease. Divide the groups of people into healthy control group, i.e. without Parkinson's disease and groups with various degree of Parkinson's disease.

Constructing a database by recording the speech under three different settings. Each recording should be at least 30s.

Recording 1: Speech with neutral emotion, e.g. reading a phone book; Recording 2: free speech in positive emotion, e.g. speaking about a friend's wedding; then Recording 3: free speech in negative emotion, e.g. speaking about car accident.

Alternatively, the database could also be constructed under following settings:

Recording 1: Speech with neutral emotion, e.g. reading a phone book; Recording 2: singing a familiar song or text; then Recording 3: formal speech or public speaking

Analyzing each of the recordings within the groups of the people, extracting relevant audio features and construct the database of the groups mapping out audio features in relationship to the physiological states, e.g. healthy or with Parkinson's disease. The audio feature acquired from a specific subject with unknown physiological state is compared to the constructed database, which result in the categorizing the physiological state of the subject.

### EXAMPLE 5

Recruiting groups of people in the process of rehabilitation, e.g. people that cannot move as they use to and a group of people that are not in the rehabilitation. Divide the groups of people into healthy control group, i.e. not in the rehabilitation process, and groups in various progress level of rehabilitation.

Constructing a database by recording the speech under three different settings. Each recording should be at least 30s.

Recording 1: Speech with neutral emotion, e.g. reading a phone book; Recording 2: free speech about current feelings; then Recording 3: free speech about feelings in yesterday.

Alternatively, the database could also be constructed under following settings: Recording 1: Speech with neutral emotion, e.g. reading a phone book; Recording 2: free speech before the rehabilitation exercise; then Recording 3: free speech after the rehabilitation exercise.

Analyzing each of the recordings within the groups of the people, extracting relevant audio features and construct the database of the groups mapping out audio features in relationship to the physiological states, e.g. healthy or in various progress level of rehabilitation. The audio feature acquired from a specific subject with unknown physiological state is compared to the constructed database, which result in the categorizing the physiological state of the subject.

### EXAMPLE 6

Recruiting groups of people with Asperger's Syndrome, which is characterized having problem of feeling disconnected from others, and a group of people that do not have Asperger's Syndrome. Divide the groups of people into healthy control group, i.e. without Asperger's Syndrome, and groups with various degree of Asperger's Syndrome.

Constructing a database by recording the speech under three different settings. Each recording should be at least 30s.

Recording 1: Speech with neutral emotion, e.g. reading a phone book; Recording 2: free speech before receiving loving and/or affectionate message; then Recording 3: free speech after receiving loving and/or affectionate message.

Analyzing each of the recordings within the groups of the people, extracting relevant audio features and construct the database of the groups mapping out audio features in relationship to the physiological states, e.g. healthy or with various degree of Asperger's Syndrome. The audio feature acquired from a specific subject with unknown physiological state is compared to the constructed database, which result in the categorizing the physiological state of the subject.

### EXAMPLE 7

Recruiting groups of people with Posttraumatic stress disorder (PTSD) and a group of people that do not have PTSD. Divide the groups of people into healthy control group, i.e. without PTSD, and groups with various degree of PTSD.

Constructing a database by recording the speech under three different settings. Each recording should be at least 30s.

Recording 1: Speech with neutral emotion, e.g. reading a phone book; Recording 2: free speech during the process of yoga; then Recording 3: free speech hours before or after yoga.

Analyzing each of the recordings within the groups of the people, extracting relevant audio features and construct the database of the groups mapping out audio features in relationship to the physiological states, e.g. healthy or with various degree of PTSD. The audio feature acquired from a specific subject with unknown physiological state is compared to the constructed database, which result in the categorizing the physiological state of the subject.

### EXAMPLE 8

Recruiting groups of people under treatment of traditional Chinese medicine, e.g. Ginseng, and a group of people that do not take any traditional Chinese medicine. Divide the groups of people into control group, i.e. not taking any traditional Chinese medicine, and groups under treatment of traditional Chinese medicine.

Constructing a database by recording the speech under three different settings. Each recording should be at least 30s.

Recording 1: Free speech before taking a traditional Chinese medicine; Recording 2: free speech shortly after taking the traditional Chinese medicine, e.g. 1 h; then Recording 3: free speech long after taking the traditional Chinese medicine, e.g. 6 h.

Analyzing each of the recordings within the groups of the people, extracting relevant audio features and construct the database of the groups mapping out audio features in relationship to the physiological states, e.g. not taking any traditional Chinese medicine or under treatment of traditional Chinese medicine. The audio feature acquired from a specific subject with unknown physiological state is compared to the constructed database, which result in the categorizing the physiological state of the subject.

1. A method for categorizing a physiological state of a subject, comprising steps of:
a. constructing a database of audio features of groups of individuals;
b. acquiring at least one audio feature of said subject;
c. comparing said at least one audio feature with said database of audio features; and
d. categorizing said subject to a predefined group within said groups of individuals;
wherein said step of constructing said database comprises steps of:
i. acquiring physiological state data of each of predefined group of individuals; and
ii. recording audio features of said individuals in a sequence of (I) at least one first intensity stimuli, (II) at least one second intensity stimuli, and (III) at least one third intensity stimuli, and associating said audio features to said physiological state data of said group of individuals in a predetermined manner;
said step of categorizing is by matching said at least one audio feature of said subject with the nearest fit of said audio features of said individuals from said database.

2. The method according to claim 1, wherein said at least one first intensity stimuli is ‘neutral’.

3. The method according to claim 1, wherein said at least one second intensity stimuli is ‘positive’.

4. The method according to claim 1, wherein said at least one third intensity stimuli is ‘negative’.

5. The method according to claim 1, wherein said at least one first, said at least one second and said at least one third intensity stimuli are selected from a group consisting sets of ‘high’, ‘medium’ and ‘low’; ‘medium’, ‘high’, and ‘low’; ‘medium’, ‘low’, and ‘high’; ‘low’, ‘medium’, ‘high’; and ‘low’, ‘high’, ‘medium’.

6. The method according to claim 1, wherein said at least one first, said at least one second and said at least one third intensity stimuli are selected from a group consisting sets of neutral, before and after a predetermined treatment, neutral, in the process of and after a predetermined treatment, before, shortly after and long after a predetermined treatment.

7. The method according to claim 1, wherein said physiological state data is related to medical condition selected from the group consisting of Congestive heart failure (CHF), Coronary artery disease (CAD), Cerebrovascular accident (CVA), cancer, motion disorder, neurological disease, Alzheimer's disease, Parkinson's disease, back pain, gastrointestinal diseases, Asperger's Syndrome, Posttraumatic stress disorder (PTSD), rehabilitation, and any combination thereof.

8. The method according to claim 1, wherein said at least one audio feature is selected from the group consisting of valence, arousal, temper, voice frequency, speaking rate, amplitude, vocal distortion, Mel-frequency cepstral coefficient (MFCC), and any combination thereof.

9. The method according to claim 1, wherein said recording lasts at least 30s.

10. The method according to claim 1, wherein said recording is performed using a microphone or a sound recorder.

11. The method according to claim 1, further comprising the step of transforming said recording into computer readable medium (CRM).

12. The method according to claim 1, wherein said recording is stored on a tape, a CD, a digital media, a computer, a smart-phone, a tablet and any combination thereof.

13. The method according to claim 12, wherein said recording is stored temporarily or permanently in forms of file format selected from the group consisting of way, wma, mp2, mp3, m4p, ram, and any combination thereof.

14. A system for categorizing a physiological state of a subject, comprising:
a. a sound recording means configured to record speeches from said subject or groups of individuals for the duration of a sample period,
b. a database of audio features of groups of individuals;
c. a processor in communication with said recorder, for processing said speeches from said subject and groups of individuals so as to acquire audio features of said speeches and for categorizing said subject by matching said at least one audio feature of said subject with the nearest fit of said audio features of said individuals from said database;
wherein said database is constructed following steps of:
i. acquiring physiological state data of each of predefined group of said individuals; and
ii. recording audio features of said individuals in a sequence of (I) at least one first intensity stimuli, (II) at least one second intensity stimuli, and (III) at least one third intensity stimuli, and associating said audio features to said physiological state data of said group of individuals in a predetermined manner.

15. The system according to claim 14, wherein said at least one first intensity stimuli is ‘neutral’.

16. The system according to claim 14, wherein said at least one second intensity stimuli is ‘positive’.

17. The system according to claim 14, wherein said at least one second intensity stimuli is ‘negative’.

18. The system according to claim 14, wherein said at least one first, said at least one second and said at least one third intensity stimuli are selected from a group consisting sets of ‘high’, ‘medium’ and ‘low’; ‘medium’, ‘high’, and ‘low’; ‘medium’, ‘low’, and ‘high’; ‘low’, ‘medium’, ‘high’; and ‘low’, ‘high’, ‘medium’.

19. The system according to claim 14, wherein said at least one first, said at least one second and said at least one third intensity stimuli are selected from a group consisting sets of neutral, before and after a predetermined treatment, neutral, in the process of and after a predetermined treatment, before, shortly after and long after a predetermined treatment.

20. The system according to claim 14, wherein said physiological state data is related to medical condition selected from the group consisting of Congestive heart failure (CHF), Coronary artery disease (CAD), Cerebrovascular accident (CVA), cancer, motion disorder, neurological disease, Alzheimer's disease, Parkinson's disease, back pain, gastrointestinal diseases, Asperger's Syndrome, Posttraumatic stress disorder (PTSD), rehabilitation, and any combination thereof.

21. The system according to claim 14, wherein said at least one audio feature is selected from the group consisting of valence, arousal, temper, voice frequency, speaking rate, amplitude, vocal distortion, Mel-frequency cepstral coefficient (MFCC), and any combination thereof.

22. The system according to claim 14, wherein said sample period lasts at least 30s.

23. The system according to claim 14, wherein said audio means is microphone or sound recorder.

24. The system according to claim 14, further comprises storage unit for said recording.

25. The system according to claim 24, wherein said storage unit is selected from the group consisting of a tape, a CD, a digital media, a computer, a smart-phone, a tablet and any combination thereof.

26. The system according to claim 24, wherein said recording is stored in said storage unit temporarily or permanently in forms of file format selected from the group consisting of way, wma, mp2, mp3, m4p, ram, and any combination thereof.
